(19) United States
(12) Patent Application Publication
(10) Pub. No.: US 2024/0109275 A1
(43) Pub. Date: Apr. 4, 2024

(54) Biodegradable composite material for containers

(71) Applicant: SULAPAC OY, Helsinki (FI)

(72) Inventors: Heidi Peltola, Helsinki (FI); Antti Pärssinen, Helsinki (FI); Kati Meriläinen, Helsinki (FI)

(21) Appl. No.: 18/276,261

(22) PCT Filed: Feb. 8, 2022
(86) PCT No.: PCT/FI2022/050077

§ 371 Date: Aug. 8, 2023

(30) Foreign Application Priority Data
Feb. 8, 2021 (FI) 20215129

(51) Int. Cl. B32B 27/08; B29C 45/00; B29C 45/16; B32B 1/00; B32B 3/04; B32B 3/30; B32B 7/02; B32B 27/20; B32B 27/36; B65D 1/10; B65D 25/14; B65D 41/04; B65D 65/46; C08L 67/04

(52) U.S. Cl. CPC B32B 27/08; B29C 45/0001; B29C 45/0003; B29C 45/16; B32B 1/00; B32B 3/04; B32B 3/30; B32B 7/02; B32B 27/20; B32B 27/36; B65D 1/10; B65D 25/14; B65D 41/04; B65D 65/466; C08L 67/04; B29K 2067/046; B29K 2995/0097; B32B 2250/02; B32B 2250/244; B32B 2264/067; B32B 2264/104; B32B 2264/303; B32B 2307/7163; B32B 2307/7376; B32B 2435/02; B32B 2439/40; B32B 2439/70

(57) ABSTRACT

The present invention concerns a container and a closure comprised of a dual layer biodegradable composite material. In addition, the invention concerns a method for forming such container and closure, as well as use thereof. In particular, the present invention concerns a container suitable to be used with liquid cosmetic product, especially for such exposed for hot moist environmental conditions.

### BACKGROUND OF THE INVENTION

### Field of Invention

The present invention relates to a biodegradable composite material, especially a dual layer biodegradable composite material. Especially, the invention relates to a container, and a closure of the container, comprising such composite material. In addition, the invention concerns a method for forming such container and closure, as well as uses thereof. The container and closure of the present invention are suitable for use with cosmetic products.

### Description of Related Art

The mass-production of processed foods in the world has caused a significant upsurge in the amount of plastic that is used for packaging. Plastics and polymers are commonly used for food storage because they are low-cost and sanitary. With the rapid growth of domestic landfills and the catastrophic expansion of the floating Great Pacific plastic waste patch, it is vital that more sustainable solutions are used for packaging of all kinds.

As various mass-production industries e.g. food and cosmetic packaging, foodservice disposables attempt to lessen their dependence on oil-based fuels and products for economic and environmentally sustainable development, a major focus has been shifted to biopolymers as alternatives to synthetic and non-degradable materials. So far, after these disposables products are used, they are discarded into the environment and subject to slow decades lasting degradation. Consequently, an enormous amount of discarded packaging is excluded from natural recycling.

In light of the associated environmental problems, the management of plastic waste is an important environmental issue. About 320 million tonnes of plastics are produced annually and about 40% of the are used in packaging sector. More than 50% of the plastic waste go to landfill which is 60-100 million tonnes annually.

There is an urgent need for the development of biodegradable materials that can be degraded in an environmentally-friendly manner over a relatively short time. In this framework, bio-based polymers can play an important role because, unlike conventional plastics, they can help reduce emissions of toxic and greenhouse gases (e.g., carbon dioxide).

Common for all the compostable material solutions is that they exhibit relatively long shelf life in dry conditions. Therefore, they are suitable for storing dry or oily cosmetic products for extended periods of time. But in moist conditions they lose their usability, including appealing appearance, within weeks. In addition, due to poor moisture barrier properties, compostable materials will allow evaporation of water from the container, significantly decreasing the shelf-life of the packed product.

Utilizing compostable or biodegradable biomaterials in cosmetic containers is difficult because most of the cosmetics contain water and other moist ingredients. Typically, a shelf-life of up to two years is required, a target with reached by using traditional biopolymers having sufficient mechanical durability.

A second problematic issue is that cosmetic jars and similar containers are traditionally rigid, i.a. to provide for user-friendly tactility. Of available biodegradable material, polylactic acid (PLA) is capable of being used as a material in the wall of such containers.

Even if PLA has several advantages such as relatively low price and easy processing by injection moulding, it does not withstand sustained temperatures above 40° C. in the presence of water. As a result, at such conditions there can be a collapse of water repellent properties leading to premature destruction of material. Resistance against higher temperatures is essential during transportation and storing of the end-products.

There is still need for biodegradable packaging materials, especially for cosmetic products i.e. cosmetic containers, having an improved moisture resistance especially in elevated temperatures combined with good mechanical properties and environmentally-friendly degradation manner.

### SUMMARY OF THE INVENTION

It is an aim of the present invention to eliminate at least a part of the disadvantages of the prior art and to provide a novel container and closure which in particular tolerate elevated temperatures in moist conditions, reveal excellent mechanical durability and can be cost effectively manufactured.

In particular, the present invention concerns a container and a closure comprised of a biodegradable composite material, especially of a dual layer biodegradable composite material.

Thus, the present invention is based on the idea of combining two biopolymer layers which together form mechanically durable and water resistant container and closure. The first biopolymer of the first biopolymer layer being a water repellent biopolymer and the second biopolymer of the second biopolymer layer preferably being different from the first biopolymer. According to a preferred embodiment, the second biopolymer layer is a thicker layer on the surface of which the first biopolymer layer forms a thinner coating layer.

The first biopolymer of the present invention is selected from polyhydroxyalkanoates exhibiting water resistance properties. The first biopolymer is preferably mixed with up to 40% by weight of inorganic fillers, preferably talc. The second biopolymer, preferably different from the first biopolymer, is preferably mixed with up to 50% by weight of wood particles, thus forming a wood-plastic composite (WPC), although it can be used as such (without wood particles).

Thus, according to one embodiment the present invention concerns a container or a closure formed of a dual layer composite material comprising a second biopolymer layer coated with a first biopolymer layer. Especially, the inner surface of the second biopolymer layer is coated with the first biopolymer layer.

The present invention also concerns a method for forming such container and closure, as well as different uses of those.

The container and closure of the invention are especially suitable to be used together as cosmetic container.

More specifically, the present invention is mainly characterized by what is stated in the characterizing part of the independent claims.

Considerable advantages are achieved by the present invention. The present invention enables providing containers, such as thick-walled jars, that tolerate hot environmental conditions also in the presence of water but yet degrade at industrial composting conditions.

In addition, the materials—in particular the material of the inner layer—of the present invention reveal excellent degrading properties also in marine conditions.

Thus, the invention provides environmentally-friendly, mechanically durable containers with improved water resistant. In addition, the composite material of the present invention provides extended storing periods, especially in cosmetic products.

Further, the water repellent and mechanical properties of the composite material can be improved by, in one embodiment, incorporating fillers to the water repellent hydrophobic biopolymer, i.e. the polyhydroxyalkanoate. Even though these fillers reduce water absorption they still can enhance degradation of the biopolymer by forming discontinuous surfaces.

The present invention also enables simplified and cost efficient manufacturing method of containers and closures comprising the composite material of the present invention, since the water repellent biopolymer acting as a coating provides good adhesion, especially when 2K-injection moulding is utilized, wherein there is no need for additional adhesive layer between the two biopolymer layers of the composite material.

Next the invention will be examined more closely with the aid of a detailed description and referring to the attached drawings.

### BRIEF DESCRIPTION OF THE DRAWINGS

FIG. 1 shows in cross-section a schematic sideview of a jar according to an embodiment.

FIG. 2 shows in cross-section a schematic sideview of a cap according to an embodiment.

FIG. 3 shows the results of a test evaluating the resistance of the container according to one embodiment of the present invention to hot and moist conditions compared to a reference container.

FIG. 4 shows the appearance of the container according to one embodiment of the invention, and reference containers, after exposure to water.

### DETAILED DESCRIPTION OF PREFERRED EMBODIMENTS

### Definitions

In the present context, the term “container” refers to an object comprising a wall having an inside defining a cavity and an opposite outside.

Typically, the “container” is a generally fluid-proof, in particular liquid-proof, vessel capable of containing an amount or volume of material, in particular a pre-determined amount or volume of material. Thus, the “container” covers, for example, jars, flasks, bottles, pots, pitchers, jugs, drums and canisters.

Typically, the container contains a closable part (i.e. cavity) capable of holding the material, having one or more openings, and at least one closure, in particular one closure for each opening. In preferred embodiments, the closure is adapted to seal fluid- or liquid-tight—and optionally even gas-tight—against the opening of the container. In particular, the closure is adapted to seal the opening off from the ambient, to prevent leakage of material from the inside of the container to the outside. Preferably, the closure is adapted to seal the opening off from the ambient to prevent passage of fluid from the ambient into the container, such as gas from the ambient into the container.

The “closure” includes covers, caps, lids, stoppers, tops and plugs. For brevity, the term “cap” is used as a synonym for “closure”.

The term “thick-walled” container stands for containers having generally a wall thickness of more than 1.0 mm, in particular more than 1.5 mm, for example 2 mm to 50 mm, typically 2.5 to 25 mm, such as 3 mm to 10 mm.

“Rigid” when used in the context of a polymer means that the polymer, either a thermoplastic or thermosetting polymer, has elongation at break of less than or equal to 10% according to ISO 527.

The term “screened” size is used for designating particles which are sized or segregated or which can be sized or segregated into the specific size using a screen having a mesh size corresponding to the screened size of the particles.

Migration tests carried out in compliance with regulation (EU) No. 10/2011 are carried out for example pursuant to EN1186-3:2002 standard, describing the testing procedure for overall migration testing, or EN13130 standard, describing the general testing procedure for specific migration testing including analytical measurements.

Unless otherwise stated, the term “molecular weight” or “average molecular weight” refers to weight average molecular weight (also abbreviated “MW”).

Unless otherwise stated herein or clear from the context, any percentages referred to herein are expressed as percent by weight based on a total weight of the respective composition.

Unless otherwise stated, properties that have been experimentally measured or determined herein have been measured or determined at room temperature. Unless otherwise indicated, room temperature is 25° C.

2K moulding or 2K injection moulding stands for 2-shot, multi-component injection molding or co-injection.

In the context of the present invention terms “first biopolymer layer”, “first layer”, “coating layer” and “inside layer” are used as synonyms referring to a biopolymer layer comprising the first biopolymer. Similarly, terms “second biopolymer layer”, “second layer” and “outside layer” are used as synonyms to each other referring to a biopolymer layer comprising the second biopolymer, preferably different from the first biopolymer.

The materials of the first layer, the second layer or both are preferably suitable as Food Contact Materials (FCMs), as provided for under Regulation (EC) No 1935/2004.

### Container

The present invention relates to biodegradable composite materials for containers.

As referred to above, the present containers are objects having a wall with an inside defining a cavity and an opposite outside. According to a preferred embodiment the cavity of the container has a closable opening.

The shape of the container is not limited in any way, it can have any shape, such round or square shape. However, according to a preferred embodiment the container has round shape, standing for a spherical cross-section, which is practical for most uses and whereby it is readily manufactured.

Typically, the present containers are capable of holding 1 to 10,000 ml of material, typically 5 to 1000 ml, for example 10 to 250 ml, such as 15 to 200 ml or 20 to 100 ml. The present containers are capable of containing 1 to 10,000 g of material, typically 5 to 1000 g, for example 10 to 250 g, such as 15 to 200 g or 20 to 100 g of material.

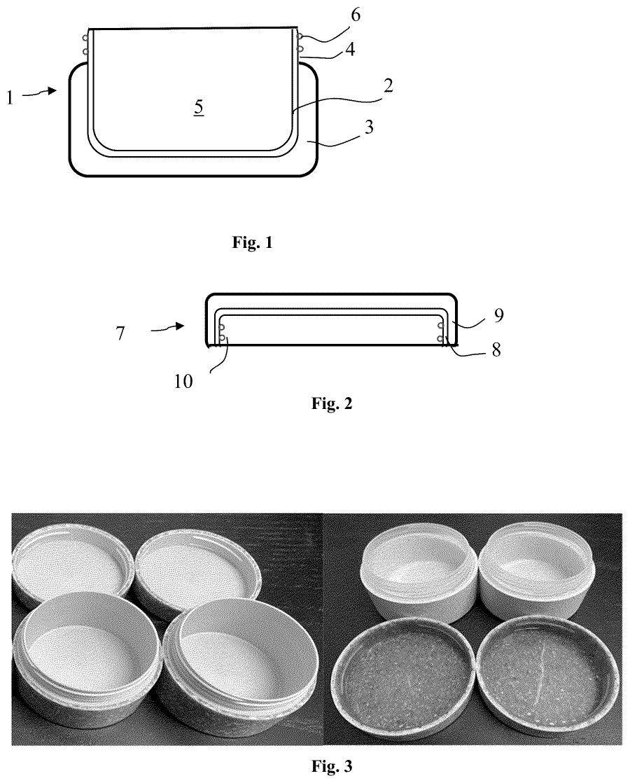

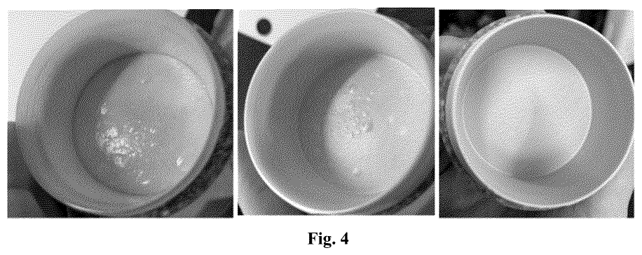

As will appear from FIG. 1, according to an embodiment of the present technology, a container 1 is formed from a dual layer 2, 3 of biodegradable composite materials. According to a preferred embodiment, the inside of the wall of the container is formed by a first layer 2 of first biopolymer and the outside wall 3 is formed of a second layer of a second biopolymer. Preferably, the second layer overlaps with the first layer, enclosing it partially. As shown in FIG. 1, the first layer extends past the second layer at the opening of the container to form a collar 4, which defines the opening into the cavity 5 of the container. According to one embodiment the dual layer composite material is a material having two different biopolymer layers which are attached to each other, thus forming a composite material. According to a preferred embodiment the layers are attached to each other without a separate adhesive material.

Thus, according to one embodiment the composite material comprises a layer of a biopolymer (i.e. a layer of the second polymer), which is coated on its inner surface with first biopolymer layer, i.e. coating layer.

As shown in FIG. 1, the first layer extends past the second layer at the opening of the container to form a protruding collar 4, which defines the opening into the cavity 5 of the container 1.

According to one embodiment, as further illustrated by FIG. 1, the collar formed by the first layer 2 comprises threads 6 formed into the first layer. In particular, the threads are formed on the outside surface of the collar 4. The threads are adapted to match a corresponding surface on the inside of a closure for the container 1.

FIG. 2 shows a closure or cap which has a similar structure with a first layer 8 of a first polymer which preferably is of the same material as the first layer 2 of the container. On the outside, there is a second layer 9, which preferably is of the same material as the second layer 3 of the container. On the inside surface of the first layer 8 there are threads 10 which are adapted to match the outside surface protruding collar 4 of the container.

The first layer of the first biopolymer has a first thickness and the second layer of the second biopolymer has a second thickness. Preferably, the second thickness is greater than the first thickness. According to one embodiment, the ratio between the first thickness and the second thickness is 1:1.25 to 1:25, for example 1:2 to 1:10, in particular 1:2.5 to 1:5.

According to one embodiment the first layer has a thickness of 0.1 to 5 mm, preferably 0.5 to 2 mm, for example 0.5 to 1 mm.

According to one embodiment the second layer has a thickness of 2 to 12 mm, preferably 2.5 to 10 mm, for example 3 to 8 mm.

According to a preferred embodiment, the first biopolymer of the first layer is a thermoplastic biopolymer, preferably a water repellent biopolymer selected from polyhydroxyalkanoates, in particular poly(3-hydroxybutyrate-co-3-hydroxyvalerate) (PHBV). PHBV is biodegradable, nontoxic, biocompatible plastic produced naturally by bacteria. It is a thermoplastic, linear aliphatic polyester which can be obtained by copolymerization of 3-hydroxybutanoic acid and 3-hydroxypentanoic acid. In general, polyhydroxyalkanoates have low water permeability and good thermal stability in moist conditions. In addition, polyhydroxyalkanoates are degradable in industrial composting as well as marine conditions as such, wherein polyhydroxyalkanoates do not reduce degrading when combined with thick-walled biodegradable material based on other mechanically durable biopolymer, such as PLA.

According to one embodiment the polyhydroxyalkanoate, especially poly(3-hydroxybutyrate-co-3-hydroxyvalerate), used in the present invention has a specific gravity of 1.0 to 1.5 kg/m³, for example 1.25 kg/m³. The melt flow index of the polyhydroxyalkanoate is preferably between 8 to 15 g/10 min (190° C., 2.16 kg) and tensile strength between 35 to 40 MPa.

According to one embodiment the melting point of the polyhydroxyalkanoate is greater than 150° C., in particular greater than 155° C., preferably between 150 and 200° C., for example between 165 and 180° C.

According to a preferred embodiment the polyhydroxyalkanoate is in a semi-crystalline or crystalline form after being solidified. According to one embodiment the polyhydroxyalkonate is crystallized in injection moulding using a temperature of at least 60° C., for example 80° C. Crystallized poly(3-hydroxybutyrate-co-3-hydroxyvalerate) preferably has a water permeability rate of less than 0.5 g*mm/m²*24 h in 23° C. and relative humidity of 85% and overall migration less than 1.0 mg/dm² (3 days, 40° C., 95% EtOH).

According to one embodiment the polyhydroxyalkoanate has a water permeability rate of less than 1 g*mm/m²*24 h in 23° C., preferably less than 0.5 g*mm/m²*24 h in 23° C.

According to one embodiment the first biopolymer forms the matrix of the first biopolymer layer, i.e. the coating layer. The first biopolymer layer may further comprise other components in the biopolymer matrix.

According to one embodiment, the first biopolymer layer further contains a filler, preferably an inorganic filler, more preferably a water repellent inorganic filler. In particular, the first biopolymer layer preferably comprises a mineral filler which is preferably formed by lamellar-like particles, such as talc or kaolin. By incorporating a filler or fillers to the first biopolymer layer, the water repellent and mechanical properties of the layer can be further improved. Even though these fillers typically reduce water absorption they still can enhance degradation of the biopolymer by forming discontinuous surfaces. In addition, the first biopolymer layer containing fillers, especially inorganic fillers, reveals even improved adhesion to the second biopolymer layer, especially when 2K-injection moulding is used.

Preferably talc is used as a filler, especially a talc having an average particle size between 1 to 2 μm, for example 1.8 μm, and a bulk density of 0.5 to 1 g/cm³, for example 0.7 g/cm³, preferably with a lamellar structure.

According to one embodiment the content of the filler being up to 50%, preferably 1 to 40%, more preferably 10 to 35%, for example 20 to 30%, of the total weight of the first layer.

According to one embodiment the average particle size of the fillers used in less than 10 μm, preferably less than 5 μm, more preferably less than 3 μm.

According to one embodiment the first layer consists of 60 to 90 wt. % of polyhydroxyalkanoates, preferably poly(3-hydroxybutyrate-co-3-hydroxyvalerate), and 10 to 40 wt. % filler, preferably talc, of the total weight of the first layer.

According to one embodiment, other fillers, especially mineral fillers, and/or pigments can also be present in the first biopolymer layer. Such fillers and pigments can be selected for example from the group of calcium carbonate, calcium sulphate, tricalcium, sepiolite barium sulphate, zinc sulphate, titanium dioxide, aluminium oxides, aluminosilicates, bentonite and silica based fillers, and mixtures thereof. In one embodiment, the first biopolymer layer further comprise particles of a finely divided material capable of conferring properties of color to the material. The dying material can for example be selected from natural materials having colors which are stable at the processing temperatures employed during melt-processing. In one embodiment, the dying materials are stable at temperatures of up to 200° C.

According to one embodiment the first biopolymer layer may further comprise other biodegradable biopolymer or biopolymers. The first layer may for example comprise 10 to 30 wt. %, preferably 15 to 20 wt. % of other biodegradable biopolymer or biopolymers, such as PBAT. Such further biopolymers can be used to further improve the impact resistance of the first biopolymer layer.

In addition, also additives, such as chain extenders, stabilizers, dispersants, antioxidants, cross-linkers, slipping agent or plasticizers, or any mixture thereof, can be added to the first biopolymer layer. The additives can be for example reactive grafted polymers, such as maleic anhydride grafted PLA, vegetable waxes, such as carnauba wax, fatty acid esters or blends of fatty esters, glycerol, triethyl, acetyl tributyl or tributyl citrates, citric acids, polyols, such as xylitol and sorbitol, vegetable oils, such as canola oil or linseed oil, calcium or zinc stearates, sorbitan esters, or polyvinyl alcohols. According to one embodiment, the amount of additives is 1 to 10 wt. %, preferably 1 to 5 wt. %, in particular 1 to 3 wt. %, of the total weight of the first biopolymer layer.

According to one embodiment, the material of the first biopolymer layer can be formed by melt-mixing the polyhydroxyalkanoate with the filler, pigment, additive and/or other biodegradable biopolymer. The obtained blend or mixture can then be used to form the composite material of the present invention, preferably by 2K-injection moulding on the surface, especially on the inner surface, of the second biopolymer layer.

According to a preferred embodiment the first layer forms a continuous layer essentially impermeable to water at ambient temperature.

According to one embodiment the first layer forms a continuous layer having a water evaporation of less than 4 weight-% within a 56 days testing period at a temperature of 45° C. when used as an inner layer in 2K injection molded container.

According to one embodiment, the first layer has, as a coating layer, a water permeability of less than 1.1 g*mm/m²/24 h at a temperature of 38° C. and humidity of 90%. The biopolymer of the second layer, i.e. the second biopolymer, is preferably also a thermoplastic biopolymer. However, according to a preferred embodiment, the second biopolymer is different from the first biopolymer. Thus, preferably, the second biopolymer comprises at most 20 wt. %, more preferably at most 10 wt. %, suitably at most 5 wt. %, of the first biopolymer. In one embodiment, the second biopolymer is free or essentially free from the first biopolymer.

According to one embodiment the second biopolymer is a lactide or lactic acid polymer optionally containing comonomers such as caprolactone or glycolic acid or combinations thereof, for example the polymer contains at least 80% by volume of lactic acid monomers or lactide monomers, in particular at least 90% by volume and in particular about 95 to 100% by volume lactic acid monomers.

According to one embodiment, the second biopolymer is selected from the group of lactide homopolymers, blends of lactide homopolymers and other biodegradable thermoplastic homopolymers, such as PBAT, PBS or combinations thereof.

According to one embodiment, the second biopolymer is selected from the group of lactide homopolymers, blends of lactide homopolymers and other biodegradable thermoplastic homopolymers, such as PBAT, PBS or combinations thereof, with 5-99 wt. %, in particular 40 to 99 wt. %, of an lactide homopolymer and 1-95 wt. %, in particular 1 to 60 wt. %, of a biodegradable thermoplastic polymer, and copolymers or block-copolymers of lactide homopolymer and any thermoplastic biodegradable polymer.

According to one embodiment 5 to 99 wt. %, in particular 40 to 99 wt. % of repeating units derived from lactide and 1 to 95 wt. %, in particular 1 to 60 wt. %, repeating units derived from other polymerizable material.

In one embodiment, polylactic acid or polylactide (which both are referred to by the abbreviation “PLA”) is employed. One particularly preferred embodiment comprises using PLA polymers or copolymers which have weight average molecular weights (Mw) of from about 10,000 g/mol to about 600,000 g/mol, preferably below about 500,000 g/mol or about 400,000 g/mol, more preferably from about 50,000 g/mol to about 300,000 g/mol or about 30,000 g/mol to about 400,000 g/mol, and most preferably from about 100,000 g/mol to 20 about 250,000 g/mol, or from about 50,000 g/mol to about 200,000 g/mol.

PLA can be crystalline, semi-crystalline or amorphous.

In one embodiment, the PLA is in the semi-crystalline or partially crystalline form. To form semi-crystalline PLA, it is preferred that at least about 90 mole percent of the repeating units in the polylactide be one of either L- or D-lactide, and even more preferred at least about 95 mole percent.

Poly(butylene adipate-co-terephthalate) (PBAT) and poly(butylene succinate) (PBS) are synthetic thermoplastic polymers, derived either from fossil-based or partly renewable based resources. PBAT and PBS are biodegradable polymers but they are both relatively soft and flexible materials. Therefore, they are not so suitable for durable coatings as such, as the inner layer of containers with threads require certain stiffness from the material, but rather as a mixture with other biopolymer, such as PLA.

According to one embodiment the second biopolymer is polylactic acid (PLA). PLA is a synthetic thermoplastic polyester derived from renewable resources and is one of the most common bioplastics in use today. Although considered biodegradable, PLA is also quite durable in most applications.

According to one embodiment, the second layer comprising the second biopolymer, preferably being different from the first biopolymer, further optionally comprises up to 50% by weight of wood particles, although the second biopolymer can be used as such.

According to a preferred embodiment the second biopolymer layer is a composite, especially a wood-plastic composite (WPC), material already itself. In such second biopolymer layer, the biopolymer forms a matrix in which the wood particles are distributed.

The wood particles can be for example in the form of wood flour, wood granules or wood shavings or any combination thereof. The wood particles can also be in any other suitable form. According to a preferred embodiment the wood particles has a screened size of less than 2.5 mm, in particular less than 2 mm, such as less than 1 mm, for example less than 0.

The wood particles can be derived from any wood material i.e. from softwood or hardwood including for example pine, spruce, larchwood, juniper, birch, alder, aspen, poplar, eucalyptus and mixed tropical wood, as well as combinations thereof. In a preferred embodiment, the wood material is selected from hardwood, in particular from hardwood of the Populus species, such as poplar and aspen.

Wood particles enables properties of melt-processibility for the second biopolymer layer by combining the biopolymer and wood particles such a way that the biopolymer forms a continuous matrix in which the wood particles are distributed, preferably evenly distributed. Use of wood particles in the biopolymer composition cuts cost of the material and make the material truly compostable. Especially, by using non-conferous wood materials, gaseous emissions of terpenes and other volatile components, typical for conferous wood species, can be avoided during melt processing.

According to one embodiment the second coating layer comprises 5 to 50 wt. %, preferably to 40 wt. %, for example 20 to 35 wt. %, wood particles calculated from the total weight of the second layer.

According to one embodiment the second layer consist of 60 to 90% of polylactide and 10 to 40% of wood particles of the total weight of the second layer.

According to one embodiment the first biopolymer is selected from polyhydroxyalkanoates, especially PHBV, and the second biopolymer is PLA, wherein water evaporation through PLA based container can be significantly reduced still remaining the mechanical durability of the PLA material itself. It has been surprisingly found in the present invention that despite of different crystallization and shrinkage properties of these two materials, they are compatible with each other. Thus, due to the similar chemical structure of PHBV and PLA they reveal excellent adhesion between them. Due to this, reduced peeling effect of the coating layer, i.e. the first biopolymer layer, can be observed.

According to one embodiment the first and the second biopolymer layers are adhered to each other, preferably molecularly adhered. Thus, according to a preferred embodiment, there is no need for separate adhesion material.

Thus, according to one embodiment, the present invention concerns a container comprising a wall having an inside defining a cavity and an opposite outside, the cavity having a closable opening, wherein
the inside is formed by a first layer of first biopolymer, selected from polyhydroxyalkanoates, having a first thickness, and the outside is formed by a second, overlapping layer of a second biopolymer different from the first biopolymer with up to 50% by weight of wood particles and having a second thickness, the second thickness being greater than the first, and the first and second layers being molecularly adhered to each other, and
the first layer extending past the second layer to form a collar which defines the closable opening of the cavity.

According to one embodiment the first and the second biopolymer exhibit melting points in overlapping ranges at temperatures from 150 to 200° C., in particular from 175 to 190° C.

### Closure

The present invention also concerns a closure for the container of the present invention. The closure comprises a cap having an inside defining a cavity and an opposite outside.

According to a preferred embodiment the closure is formed of the same biodegradable composite materials as the container of the present invention.

Thus, in an embodiment, the first polymers of the container and the closure are selected from the ones listed above in connection with the description of the container.

Thus, in an embodiment, the second polymers of the container and the closure are selected from the ones listed above in connection with the description of the container.

According to one embodiment the inside of the cap of the closure is formed by a first layer of the first biopolymer and the outside is formed by a second, overlapping layer of a second biopolymer different from the first biopolymer.

According to one embodiment the inside of the cap has a surface capable of closing tightly around the collar of the container. According to preferred embodiment the inside surface is capable of closing gas tightly against the volar of the container.

According to further embodiment the inside surface exhibits threads or a sealing or both to allow for sealing against the collar of the container.

FIG. 2 shows a closure or cap which has a similar structure with a first layer 8 of a polymer which preferably is of the same material as the first layer 2 of the container. On the outside, there is a further layer 9, which preferably is of the same material as the second layer 3 of the container. On the inside surface of the first layer 8 there are threads 10 which are adapted to match the outside surface protruding collar 4 of the container.

In the closure, the first layer of the closure is formed by a first biopolymer which has a first thickness and the second layer of the closure is a second biopolymer having a second thickness. Preferably, the second thickness of the closure is greater than the first thickness of the closure. According to one embodiment, the ratio between the first and the second thickness is 1:1.1 to 1:25, for example 1:1.25 to 1:10, in particular 1:2.5 to 1:5.

According to one embodiment the first layer of the closure has a thickness of 0.1 to 5 mm, preferably 0.5 to 2 mm, for example 0.5 to 1 mm.

According to one embodiment the second layer has a thickness of 2 to 12 mm, preferably 2.5 to 10 mm, for example 3 to 8 mm.

According to one embodiment the present invention relates to a closure for the container of the present invention, comprising a cap having an inside defining a cavity and an opposite outside, wherein the inside of the cap is formed by a first layer of a first biopolymer, selected from polyhydroxyalkanoates, having a first thickness, and the outside is formed by a second, overlapping layer of a second biopolymer different from the first biopolymer with up to 50% by weight of wood particles and having a second thickness, the second thickness being greater than the first, and the first and second layers of the closure being molecularly adhered to each other, and
the inside of the cap has a surface capable of closing tightly against or about the collar of the container.

Typically, in moist conditions, moisture absorption in the wood particles, preferably present in the second biopolymer layer, combined with high temperature induces movements of the biopolymer matrix causing deformations of the wood-plastic composite (WPC). The moisture related change in volume increases with the size of the wood particles. This results in increased deformation and increased inner tensions in WPC with larger flakes or fibres. The greater tension in the WPC results in micro cracks and exposes the wood filler to oxygen and moisture and increases the overall surface area. This, in turn, results in fungal attack and decreased tensile strength. Wood particles that are exposed to water over a long period of time suffer a loss in tensile strength. The decreased tensile strength is thus not only a consequence of the cracks but also from the increase in exposed wood particles and the decreased tensile strength of the exposed wood particles. The size and shape of the chips or fibres of the wood particles also change during the compounding. However, in the present technology problems relating to the swelling are solved by the water repellent biopolymer layer, i.e. the first biopolymer layer, covering such second biopolymer layer from the moisture, especially from the moisture of the product inside the container.

In the above embodiments, a threaded coupling is shown for closing the closure against the collar of the container. In addition to the threaded surfaces or as an alternative thereto, the coupling can also comprise various sealing rings to achieve a tight closing of the container with the closure.

### Manufacture

Further, the present technology also relates to a method of forming a container or closure of the present invention.

According to a preferred embodiment the method of the present invention is based on melt-processing, preferably in combination with injection moulding, in particular 2K-injection moulding. 2K-injection moulding is an injection moulding method comprising two injection steps, wherein two materials with different properties can be processed into one end product in one injection moulding process, providing significant cost advantage.

Further advantage of 2K-injection moulding is the constant process and the fact that manual insertion is not required, thus avoiding the risk of damaging the other component. It also provides advantage in cycle time when compared to other coating processes, such as spraying. Spraying is time-consuming as it requires a separate processing step and it often provides ineffective adhesion between the materials, as well as challenges in reaching the needed food contact approval and biodegradation of the whole container system. The material of the present invention produced by 2K-injection moulding does not require any additional gluing layer which is traditionally used for improving adhesion between coating and core material.

2K-injection moulding is also an excellent technique when smooth surface for coating is needed. Surface smoothness of the container product influence significantly into to the water absorption and degrading rate of the composite material. In addition, by utilizing 2K-injection moulding to apply the first biopolymer on the surface of the second biopolymer layer, it is possible to produce a coating having sufficient mechanical properties to prevent peeling. Yet, one of the major advantages of 2K-injection moulding compared to overmoulding, is that the biopolymer to be injected is still hot and has not shrunk yet. This virtually excludes the risk of burrs being formed on the second component. In addition, the surface is “virginally” clean, enabling good molecular adhesion.

It should be noted that the following description is equally applicable, mutatis mutandis, to the manufacture of a closure. As explained above, the first and second polymers and polymer materials of the container can be used as the corresponding first and second polymers and polymer materials of the closure.

According to one embodiment of the method of the invention for forming a container, there is first provided the first biopolymer and the second biopolymer. According to a preferred embodiment, both biopolymers are provided as blends or mixture. Both blends or mixtures are separately produced by melt-processing of the desired components at a suitable temperature.

According to one embodiment, the first biopolymer blend or mixture comprises the first biopolymer and optionally the additional components described above, such as a filler, additive or other biopolymer.

Thus, according to one embodiment, the first biopolymer blend or mixture is formed by melt-mixing the first biopolymer and optional additional components, especially a filler, together by using a co-rotating twin-screw extruder. For example, PHBV and 30 wt.-% talc are melt-mixed in a compounder having temperature profile of 120-160-170-160-150-150° C.

According to one embodiment, the melting temperature of the material during compounding does not exceed 180° C., preferably it does not exceed 175° C., to avoid polymer degradation. The melt flow index of the end-compound, i.e. the first biopolymer blend or mixture, should be well controlled, resulting preferably in melt flow index values of 6 to 15 g/10 min, preferably 6 to 12 g/10 min, when temperature of 190° C. and weight of 2.16 kg is used in the melt flow index determination.

There is also provided a blend or mixture of the second biopolymer, preferably comprising up to 50% by weight of wood particles, and optionally other suitable components. According to a preferred embodiment, the blend or mixture is formed by melt-mixing.

According to one embodiment, 2K-injection moulding is performed next. The 2K-injection moulding is performed in such a way that the first biopolymer forms the inner layer and the second biopolymer layer forms the outer layer. According to one embodiment, the first biopolymer layer is moulded first and the second biopolymer layer is then moulded to cover it before complete cooling of the layer of the first biopolymer. In another embodiment, the second biopolymer layer is moulded first and the first biopolymer layer is moulded after that to over the second biopolymer.

According to one embodiment, the first biopolymer layer, i.e. the inner layer, is first injection moulded, preferably to a hot mould, preferably having a temperature between 30 to 80° C., more preferably 40 to 70° C., for example 60° C. According to one embodiment the inner coating layer contains PHBV and talc. Then, the second biopolymer layer, i.e. the outer layer, is injection moulded to cover the first biopolymer layer. According to a preferred embodiment, the second layer is injection moulded in a way that the mould for the second layer is cold and the inner mould (moulding the first biopolymer layer) is hot, for example at a temperature of 60° C.

According to another embodiment, the second biopolymer layer, i.e. the outer layer, is first injection moulded, preferably to a cold mould. Then, the first biopolymer layer, i.e. the inner layer, is injection moulded. According to a preferred embodiment, the first layer is injection moulded to a hot mould, preferably having a temperature between 30 to 80° C., more preferably 40 to 70° C., for example 60° C. According to one embodiment the inner coating layer contains PHBV and talc.

According to one embodiment, the second biopolymer blend or mixture is first melt-processed into a shape of a container or a closure having an inner surface, and the container also having an opening. Then, the first biopolymer is 2K-injection moulded onto the surface of the container or closure while said surface is soft to provide a continuous layer covering the inner surface of the container or closure.

According to one embodiment, once the inner and outer surface of the container are moulded, then, a collar is formed from the first biopolymer by injection moulding at the opening. Finally, the moulded container or closure is allowed to rigidify.

Thus, according to one embodiment the present invention relates to a method of forming a container by melt-processing, comprising the steps of
providing a first biopolymer selected from polyhydroxyalkanoate optionally mixed with an inorganic filler;
providing a second biopolymer mixture containing at most 20 w-% of the first biopolymer;
moulding by melt processing the second biopolymer into the shape of a container or closure having an inner surface and an opening;
2K injection moulding the first biopolymer onto the inner surface of the container or closure while said surface is still soft to provide a continuous layer covering the inner surface of the container or closure;
forming at the opening of a collar from the first biopolymer by injection moulding; and
allowing the moulded container or closure to rigidify.

Table 1 shows the 2K-injection moulding parameters according to one embodiment of the present invention for both injections of the first biopolymer layer and the second biopolymer layer.

TABLE 1
2K-injection moulding parameters

| | Injection of the | Injection of the |
|---|---|---|
| | first layer | second layer |
| Barrel temperatures (° C.) | 60-165-175-180 | 60-150-160-170-175-190 |
| Nozzle temperatures (° C.) | 180 | 175-190 |
| Mould temperature (° C.) | 60-70 | 20-40 |
| Back temperature (bar) | 5-10 | 5-10 |

According to one embodiment the cooling time of the 2K-injection is at least 10 seconds, preferably at least 30 seconds, more preferably about 60 seconds.

According to one embodiment the first biopolymer is melt-processed at a first temperature and the second biopolymer is melt-processed at a second temperature. Preferably, the first and the second temperatures are selected from temperatures in the range from 150 to 200° C., in particular 175 to 190° C.

Finally, the present invention also concerns use of the container and closure of the present invention, especially together. According to one embodiment the container can be used with the closure as a closable container or bottle for cosmetics, foodstuff or beverages.

### EXAMPLES

### Example 1: Preparation of the First Biopolymer

PBHV (ENMAT Y1000P) is dried at 80° C. for 4 hours. PHBV and talc with median particle size of 1.7 μm are fed from separate gravimetric feeders into a twin-screw extruder. PHBV is fed from the zone 1 of the extruder and talc from side feeder in the middle of the extruder. Materials are melt-mixed in composition of 70 wt.-% of PHBV and 30 wt.-% of talc using processing temperatures of 120-160-170-160-150-150° C., with a screw speed of 300 rounds per minute and total throughput of 40 kg/h. The resulting compound has a melt temperature of 174° C., torque of 75% and melt pressure of 57 to 61 bar. The produced strands are cooled down using a water-bath and granulated. Melt flow index of the resulting compound is 5.8 to 6.2 g/10 min (190° C., 2.16 kg).

### Example 2: Forming a Container and a Closure

2K-injection moulding was performed using a container mould with product diameters of container outer diameter 60±0.15 mm and inner diameter 50.5 of mm. The container holding capacity was 50 ml. The used mould temperature was 60° C. for inner coating layer, i.e. the first biopolymer layer, including PHBV and talc according to example 1, and cold (between 20 to 40° C.) for outer, PLA-wood based second layer. The thickness of the coating layer was 0.8 mm, thread thickness in the collar part 0.9 to 1.7 mm, and thickness of the wood containing outer layer was 4.1 mm.

For the container, inner coating layer was injection moulded first to hot mould. Then the wood based outer layer was injection moulded in a way that mould for PLA based material was cold and inner mould was at 60° C. For the closure, outer layer was injected first using a cold mould, and inner layer was injected after that using a mould having a temperature of 60° C. The cycle time for injection moulding was 80 seconds including the cooling.

### Example 3: Test Results

### Water Evaporation

Water evaporation properties of the 2K-injection moulded container of the present invention, having a first biopolymer layer comprising of PHBV with 30 wt.-% talc and a second biopolymer layer comprising of PLA with wood particles, was compared to two reference containers. All the containers had the same second, i.e. outer layer, but the inner layer was different. Compositions of the inner layers are shown in Table 2, sample 2K-C being the sample according to the present invention. In other reference container the inner layer was comprised of PLA and in another of Biodolomer I, a commercial PLA based composite (as described in patent WO2013169174A1). The thickness of the inner layers of all containers was 0.8 mm and thickness of the outer layer was 4.1 mm. The closures for the containers were also produced by 2K-technique having the same configuration as the containers.

TABLE 2
Compositions of the 2K-injection moulded containers

| Sample code | Coating material | Filler (wt-%) | Outer layer |
|---|---|---|---|
| 2K-A | PLA | 0 | PLA + wood |
| 2K-B | PLA based composite | n.d. | PLA + wood |
| 2K-C | PHBV | Talc 30 wt-% | PLA + wood |

Liners were placed to all samples to ensure adequate tightening of the containers. The containers were filled with water. Three of each container type (A, B, C) were stored both at room temperature and in an oven at a temperature of 45° C. in room humidity. In addition, containers with 2K-C inner layer were tested at 50° C. for 4 weeks. Two of each type of containers were kept unopened, and the weight change of the containers were measured every week. One of each container types were opened weekly for visual evaluation to examine for cracks, wall collapse, discoloration, and other signs of incompatibility. The test was continued for 12 weeks. After the test was completed, all the containers were weighed one last time. The water was removed from the containers and the empty containers were weighed and visually examined.

The water evaporations at room temperature and at 45° C. with different inner layers after 4, 8 and 12 weeks, as well as 2K-C container at 50° C. after 4 weeks, are seen in Table 3. The evaporation of water in elevated temperatures is significantly lower when 2K-C (PHBV+talc) coating is used, i.e. the coating of the present invention. The evaporation of water with other coatings (2K-A and 2K-B) are 3.7 to 5.1 times higher than with the coating of the present invention, indicating failure in long-term storage of water-based products. Water resistance of coating layers in 2K-injection moulded containers after 12 weeks at 45° C., corresponding to over one year shelf-life, are seen in FIG. 2. Thus, FIG. 2 shows the appearance of the containers after 12 weeks water exposure at 45° C. (left 2K-A, middle 2K-B, right 2K-C). It can be seen that 2K-C coating maintains its mechanical and visual characteristics after 12 weeks exposure to water. However, 2K-A (PLA) coating crystallizes and cracks leading to failing of the container, and 2K-B (PLA based composite) starts to create bubbles between the layers, indicating failing of the adhesion between the polymer layers. Water evaporation of 2K-C containers at 50° C. was still two times lower than the reference containers at 45° C., without any visual changes of the container, as seen from Table 3.

TABLE 3
Water evaporation at room temperature, 45° C. and 50° C.
Water evaporation (%)

| | 2K-A | | 2K-B | | 2K-C | | |
|---|---|---|---|---|---|---|---|
| Days | RT | 45° C. | RT | 45° C. | RT | 45° C. | 50° C. |
| 28 | 0.35 | 7.7 | 0.05 | 5.6 | 0.07 | 1.5 | 2.5 |
| 56 | 1.0 | 14.5 | 0.7 | 10.9 | 0.3 | 3.3 | n.d. |
| 84 | 1.7 | 23.4 | 1.4 | 16.4 | 0.7 | 5.9 | n.d. |

### Resistance to Hot and Moist Conditions

Resistance to hot and moist conditions of the container of the present invention was investigates and compared to two reference 2K-injection moulded containers. All the containers had the same outer layer, i.e. the second biopolymer layer, comprising PLA and wood. Compositions of the inner layers are shown in table 3, sample 2K-C being the sample according to the present invention. Such containers were suspected to high humidity and temperature (24 h, 45° C., 95% relative humidity). As a result, the coating of the container having a PLA coating crystallized and cracked, leading to insufficient coating performance. The coating of the present invention had no changes after the exposure to hot and moist conditions. The containers and closures after the exposure can be seen in FIG. 1. Container with the coating of the present invention is presented on the left side, and the container with PLA coating is presented on the right side.

### Cyclic Atmospheric Test

The containers of table 3 were also subjected to cyclic atmospheric tests by varying conditions with the following: −10° C., rH=35%, 24 h; room temperature (23° C.), rH=50%, 24 h; 45° C., rH=75%, 24 h; room temperature (23° C.), rH=50%, 24 h. The cycle was repeated three times. No visual changes or coating peeling were observed after cyclic testing with minimal weight change of +0.6%.

Evaporation and Compatibility with Water-Based Emulsions

Further, the evaporation and compatibility of the containers (shown in Table 2, 2K-C being the present invention) with a water-based emulsion was tested at 40° C. The water content of the emulsion was 73%, other components being isohexadecane, caprylic/capric triglyceride, glycerin, dicaprylyl ether, decyl oleate, butyrospermum parkii (shea) butter, dimethicone, glyceryl stearate, PEG-100 stearate, C12-13 alkyl lactate, arachidyl alcohol, saccharide isomerate, arachidyl glucoside, behenyl alcohol, allantoin, hydroxyethyl acrylate/sodium acryloyldimethyl taurate copolymer, phenoxyethanol, methylparaben, triethanolamine, ethylparaben, citric acid and sodium citrate. Three containers of each type (2K-A, 2K-B, 2K-C), including liner, were filled with emulsion and closed with a torque meter. The water evaporation as well as resistance to cracking and visual changes were evaluated after 4, 8 and 12 weeks. The used method was identical to as described in the water evaporation experiment. As shown in Table 4, after 12 weeks, water evaporation was 2.7% at 40° C. for 2K-C container, whereas water evaporation for 2K-A and 2K-B were 10.7% and 11.5%, respectively. In the 2K-A and 2K-B containers, some twisting of the threads were detected, while 2K-C container and its threads remained unchanged. The emulsion was clearly thickened in 2K-A and 2K-C containers, correlating to the water evaporation rates. No visually observable changes could be detected in emulsion stored in 2K-C container.

TABLE 4
Evaporation of water-based emulsion in different containers

| | Evaporation (%) at 40° C. | | |
|---|---|---|---|
| | 2K-A | 2K-B | 2K-C |
| 28 days | 3.7 | 4.0 | 0.9 |
| 56 days | 7.1 | 7.7 | 1.8 |
| 84 days | 10.7 | 11.5 | 2.7 |

### Migration

Migration levels of various first biopolymer layers were investigated by migration test to study inertness of various material compositions in contact with different simulants by filling method. The migration tests were conducted according to EN 1186-9 and EN 1186-14 analysis methods. Aqueous simulants (10% ethanol and 3% acetic acid (ac)) were used, of which acetic acid simulates conditions with pH<4.5, and 10% ethanol partly lipophilic simulates conditions such as water-oil emulsions. To substitute vegetable oil, 95% ethanol was used to simulate fatty foodstuffs. The test conditions selected were 3 days and 10 days at 40° C., which corresponds to any long term storage at room temperature or below, including heating up to 70° C. for up to 2 hours, or heating up to 100° C. for up to 15 minutes. According to Regulation (EC) 10/2011 on plastic materials intended for food contact, overall migration should not exceed 10 mg/dm². The compositions of the first layers and results of the migration tests in 95% EtOH, 3 days are shown in Table 5.

TABLE 5
Migration test

| | | 95% EtOH | 10% EtOH | 3% ac |
|---|---|---|---|---|
| | Filler | mg/dm2 | mg/dm2 | mg/dm2 |
| Material | (wt-%) | 10 days | 10 days | 10 days |
| PHBV | Talc (30) | <1 | <1 | 4.6 |

### Biodegradation

The properties of various first biopolymer layers were also investigated by a marine aerobic biodegradation test. The tests in marine conditions were evaluated using ASTM D6691 standard. According to the results shown in table 6, after 56 days, the material had already degraded 63.4% according to the measured net carbon dioxide production (Net CO₂). Relative biodegradation was 91.9% when compared to reference sample (pure cellulose), referring that the material is totally biodegradable in marine conditions defined by the standard. In table 6, three different rates for the biodegradation is given, average (AVG), standard deviation (SD) and relative biodegradation (REL). TOC stands for total organic carbon.

TABLE 6
Net CO₂ production and biodegradation after 56 days

| | | Net CO₂ | Biodegradation (%) | | |
|---|---|---|---|---|---|
| Test series | TOC (%) | (mg) | AVG | SD | REL |
| PHBV + 30 | 39.7 | 63.4 | 72.6 | 3.1 | 91.9 |
| wt. % talc | | | | | |

Reference materials:

| | | | | | |
|---|---|---|---|---|---|
| Cellulose | 43.6 | 75.9 | 79.0 | 3.7 | 100.0 |
| PBAT | 61.8 | 6.8 | 5.0 | 3.8 | 6.4 |
| PBS | 55.7 | 6.6 | 5.4 | 2.6 | 6.9 |
| PLA | 50.6 | 8.2 | 7.4 | 0.1 | 9.4 |

### INDUSTRIAL APPLICABILITY

The present invention can be used to produce biodegradable and mechanically durable containers and closures for such containers. The container of the present invention can generally be used for replacement of conventional packaging materials.

In particular, the present dual layer container is suitable for cosmetic and food packaging. Especially, the container can be used for cosmetic packaging having to dealt with moisture and high temperatures. The materials of the container are, in particular, also suitable as Food Contact Materials (FCMs), as provided for under Regulation (EC) No 1935/2004.

1-26. (canceled)

27. A container comprising a wall having an inside defining a cavity and an opposite outside, the cavity having a closable opening, wherein:
the inside is formed by a first layer of a first biopolymer selected from polyhydroxyalkanoates, having a first thickness, and the outside is formed by a second, overlapping layer of a second biopolymer different from the first biopolymer and having a second thickness, the second thickness being greater than the first, and the first and second layers being molecularly adhered to each other, and
the first layer extending past the second layer to form a collar which defines the closable opening of the cavity.

28. The container according to claim 27, wherein the ratio between the first thickness and the second thickness is 1:1.25 to 1:25.

29. The container according to claim 27, wherein the first biopolymer contains an inorganic filler, the content of the inorganic filler being up to 50% of the total weight of the first layer.

30. The container according to claim 27, wherein the second biopolymer contains up to 50% by weight of wood particles having a screened sized of less than 2.5 mm.

31. The container according to claim 27, wherein the second biopolymer comprises a lactide or lactic acid polymer, poly(butylene adipate-co-terephthalate) (PBAT), poly(butylene succinate) (PBS), or combinations thereof.

32. The container according to claim 27, wherein first biopolymer comprises a polyhydroxybutanoate, in particular poly(3-hydroxybutyrate-co-3-hydroxyvalerate).

33. The container according to claim 27, wherein the first biopolymer and the second biopolymer exhibit melting points in overlapping ranges at temperatures from 150 to 200° C.

34. The container according to claim 27, wherein first layer consists of 60 to 90% of poly(3-hydroxybutyrate-co-3-hydroxyvalerate) and 10-40% talc of the total weight of the first layer.

35. The container according to claim 27, wherein the second layer consists of 60 to 90% of polylactide and 10 to 40% wood particles of the total weight of the second layer.

36. The container according to claim 27, wherein the first layer forms a continuous layer having water evaporation less than 10 wt-% within 84 days testing period at a temperature of 45° C.

37. The container according to claim 27, comprising a layer of polyhydroxyalkanoate injection moulded onto a layer of the second biopolymer.

38. The container according to claim 27, wherein the first layer has a thickness of 0.5 to 2 mm and the second layer has a thickness of 2.5 to 10 mm.

39. The container according to claim 27, wherein the collar formed by the first layer comprises external threads formed into the first layer.

40. A closure for a container according to claim 27, the closure comprising a cap having an inside defining a cavity and an opposite outside, wherein:
the inside is formed by a first layer of first biopolymer, selected from polyhydroxyalkanoates, having a first thickness, and the outside is formed by a second, overlapping layer of a second biopolymer different from the first biopolymer and having a second thickness, the second thickness being greater than the first, and the first and second layers being molecularly adhered to each other, and
the inside has a surface capable of closing tightly about the collar of the container.

41. The closure according to claim 40, wherein surface of the inside exhibits threads or a sealing or both to allow for sealing against the collar of the container.

42. The closure according to claim 40, wherein the inside layer has a thickness of 0.5 to 2.5 mm.

43. The closure according to claim 40, wherein the second biopolymer contains up to 50% by weight of wood particles having a screened sized of less than 2.5 mm.

44. A method of forming the container according to claim 27 by melt-processing, the method comprising the steps of:
providing a first biopolymer selected from polyhydroxyalkanoate optionally mixed with an inorganic filler;
providing a second biopolymer mixture optionally containing up to 50% by weight of wood particles;
moulding by melt processing the second biopolymer into the shape of a container or closure having an inner surface and an opening;
2K injection moulding the first biopolymer onto the inner surface of the container or closure while said surface is still soft to provide a continuous layer covering an inner surface of the container or closure;
forming a collar from the first biopolymer by injection moulding at the opening of the container or closure; and
allowing the moulded container or closure to rigidify.

45. The method according to claim 44, wherein the first biopolymer is melt processed at a first temperature and the second biopolymer is melt processed at a second temperature, the first and the second temperatures being selected from temperatures in the range from 150 to 200° C.

46. The method according to claim 44, wherein the second biopolymer mixture contains less than 20% by weight of the first biopolymer.

47. A combination comprising a container according to claim 27, a closure according to claim 40, and a cosmetic material, foodstuff, or a beverage.
